(19) United States
(12) Patent Application Publication
(10) Pub. No.: US 2016/0155362 A1
(43) Pub. Date: Jun. 2, 2016

(54) AUDIO DATA CONVERSION

(71) Applicants: Janhavi Nitin Joshi, Pune (IN); Nupura Dattatraya Kirloskar, Pune (IN)

(72) Inventors: Janhavi Nitin Joshi, Pune (IN); Nupura Dattatraya Kirloskar, Pune (IN)

(21) Appl. No.: 14/956,144

(22) Filed: Dec. 1, 2015

(30) Foreign Application Priority Data
Dec. 2, 2014 (IN) 3558/MUM/2014

(51) Int. Cl. G09B 21/00; G09B 15/00

(52) U.S. Cl. CPC G09B 21/009; G09B 15/00

(57) ABSTRACT

A system for transforming audio data into vibrating patterns is provided. The system comprises an electronic device configured for converting audio data into vibrating pattern data; and a portable device in communication with the electronic device for receiving the vibrating pattern data, the portable device having at-least one vibrating mechanism for imparting vibrating patterns depending upon the vibrating pattern data.

### CROSS REFERENCE TO RELATED APPLICATION

This application claims priority to India patent application No. 3558/MUM/2014, filed Dec. 2, 2014, the disclosures of which are incorporated herein by reference in their entirety.

### FIELD OF THE INVENTION

The invention relates to conversion of audio data, more particularly to conversion of audio data into vibrating patterns.

### BACKGROUND OF THE INVENTION

Deafness or hearing impairment is the inability to understand speech, audio, music, even at amplified levels. Usually to communicate with the deaf or hearing impaired individuals visual or physical means such as sign language are used which is challenging, especially when one is addressing a group of deaf or hearing impaired individuals.

In spite of their inability to hear, the deaf or hearing impaired get involved in group activities like dance, team sports, etc. Usually, trainers use sign language or hand gestures like clapping, tapping to train hearing impaired or deaf individuals. However, it is difficult for the trainers to convey rhythm, speed, tune, pitch, lyrics of the music to the deaf or hearing impaired.

Also, individuals who are slow learners or beginners face difficulties in synchronizing with music.

### SUMMARY OF THE INVENTION

Accordingly, the present invention in one aspect provides a system for transforming audio data into vibrating patterns, the system comprising an electronic device configured for converting audio data into vibrating pattern data; and a portable device in communication with the electronic device for receiving the vibrating pattern data, the portable device having at-least one vibrating mechanism for imparting vibrating patterns depending upon the vibrating pattern data.

In another aspect, the present invention provides a portable device for imparting vibrating patterns, the device comprising a communication module for receiving vibrating pattern data from an electronic device, the vibrating pattern data being converted from audio data, a processor for converting vibrating pattern data into vibrating patterns, and a vibrating mechanism for imparting vibrating patterns.

In one another aspect, a method for transforming audio data into vibrating patterns, the method comprising the steps of establishing a communication link between an electronic device and at-least one portable device; receiving audio data on the electronic device; converting the audio data into vibrating pattern data on the electronic device; transferring the vibrating pattern data to each of the portable devices, the portable device imparting vibrating patterns depending upon the vibrating pattern data received from the electronic device.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 shows a block diagram of a system for transforming audio data into vibrating patterns in accordance with an embodiment of the invention.

FIG. 2 shows a block diagram of a portable device in accordance with an embodiment of the invention.

FIG. 3 shows a flow-chart of a method for transforming audio data into vibrating patterns in accordance with an embodiment of the invention.

### DETAILED DESCRIPTION OF THE INVENTION

The present invention is directed towards transforming audio data into vibrating patterns to aid/train deaf or hearing impaired individuals to perceive/sense and understand audio data such as music, speech, instructions through sense of touch i.e. the vibrating patterns.

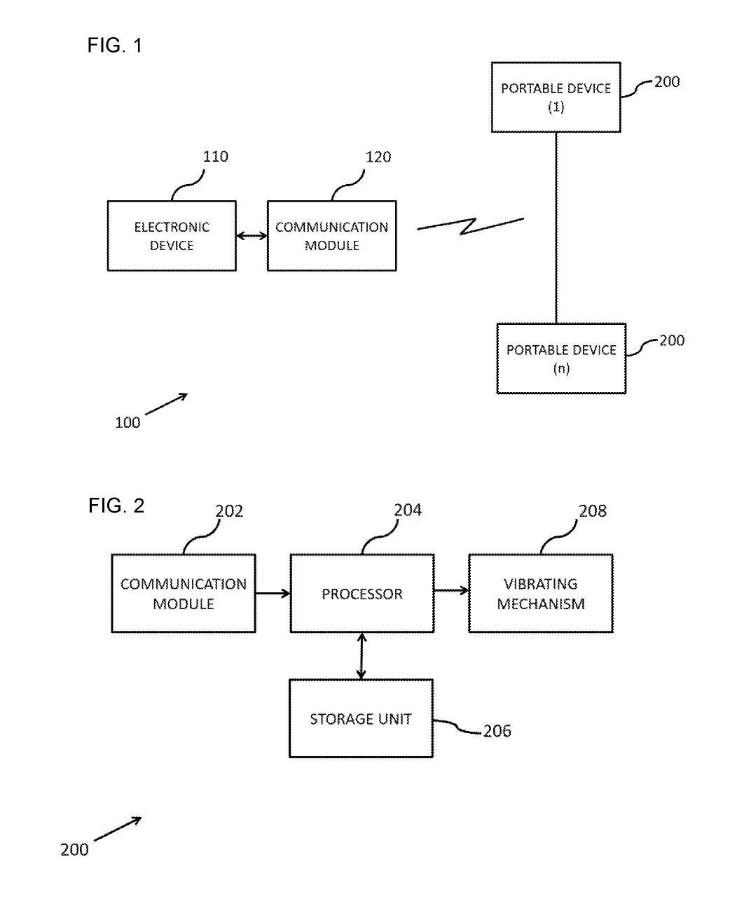

FIG. 1 shows a block diagram of a system (100) for transforming audio data into vibrating patterns in accordance with an embodiment of the invention. The system includes an electronic device (110), a communication module (120) and at-least one portable device (200).

The electronic device comprises a processor, an input device, a display and a storage unit. The processor is configured to convert audio data such as music, speech, etc into vibrating pattern data. In this regard, the electronic device includes an application embedded in the device for converting audio data into vibrating pattern data. For converting the audio data into vibrating pattern data, processor of the device analyses the audio data to detect speed as well as intensity of the audio data and depending upon the speed and intensity of the audio data corresponding vibrating pattern data having the same speed and intensity characteristics is produced. The audio data can be music which can be received or selected from an external source or is retrieved from the storage unit of the electronic device. Accordingly for music being converted speed and intensity of the music is converted into vibrating patterns having speed and intensity characteristics of the music. The audio data can also be speech of a user which can be received through a microphone of the electronic device. Accordingly for speech being converted, speed and intensity of each syllable of the speech is converted into vibrating patterns having speed and intensity characteristics of the syllables of the speech. Alternately for speech being converted, syllables in the audio data is identified, and co-related with pre-stored vibrating patterns, whereby the pre-stored vibrating pattern have speed and/or intensity corresponding to the syllables. In this regard, corresponding vibrating patters are assigned and stored for different syllables, and on receiving such syllables, the system retrieves the corresponding vibrating pattern. Further, the storage unit also has preset vibrating patterns which may not involve any conversion from audio data to vibrations. The display and/or the input unit provides a user accessibility and/or control to the system. The electronic device can be selected from a group comprising of smart phones, laptops, tablet pc, and the like.

The communication module as shown in the figure is connected to the electronic device. The communication module can be connected to the electronic device via an audio jack and/or USB modules or via wireless means. Alternately, the communication module can also be embedded in the electronic device. Further, the communication module is configured to establish communication link with one or more portable devices. In an embodiment of the invention, the communication module receives the vibrating pattern data from the electronic device and transfers it to the portable device. The communication module can be designed to operate over any one of a radio frequency network, a GSM system, a CDMA system, a Wi-Fi or WiMax network, a Bluetooth network or an infrared network.

FIG. 2 shows a block diagram of the portable device (200) in accordance with an embodiment of the invention. As shown, the portable device includes a communication module (202), a processor (204), a storage unit (206) and at-least one vibrating mechanism (208).

The communication module of the portable device is designed to operate over the same network as the communication module connected or embedded with the electronic device. Accordingly the communication module can be designed to operate over any one of a radio frequency network, a GSM network, a CDMA network, a Wi-Fi or WiMax network, a Bluetooth network or an infrared network. Once a communication link is established with the electronic device or the communication module connected to the electronic device the portable device receives the vibrating pattern data.

The processor of the portable device converts the vibrating pattern data received from the electronic device into vibrating patterns. The vibrating patterns are provided to the vibrating mechanism for imparting vibrating patterns. In an embodiment of the invention, the vibrating mechanism can be selected from a vibrating motor, a piezoelectric translator, a voice coil, and the like.

The portable device includes a rechargeable power source (not shown) for powering the portable device.

In an embodiment of the invention, the portable device is a wearable device in the form of a ring, a bracelet, a band, a watch, a smart-watch, a pendant, etc. The portable device or the wearable device in a preferred embodiment would include a main body portion such as a ring, a bracelet, a band, or other device configured to be worn by a user. Further, the portable device includes a housing attached to the main body portion for enclosing components such as communication module, processor, storage unit, vibrating motors, power source, etc. In an embodiment of the invention, the motors are provided on opposite ends of the housing such that the vibrations can be sensed at different points on the body by the user. Advantage of the portable device being in the form of a wearable device is that wearable devices are comfortable to wear and do not restrict physical movement when worn by a user. Also, such wearable devices makes absolute contact with the user imparting vibrating patterns which are felt effectively by the user.

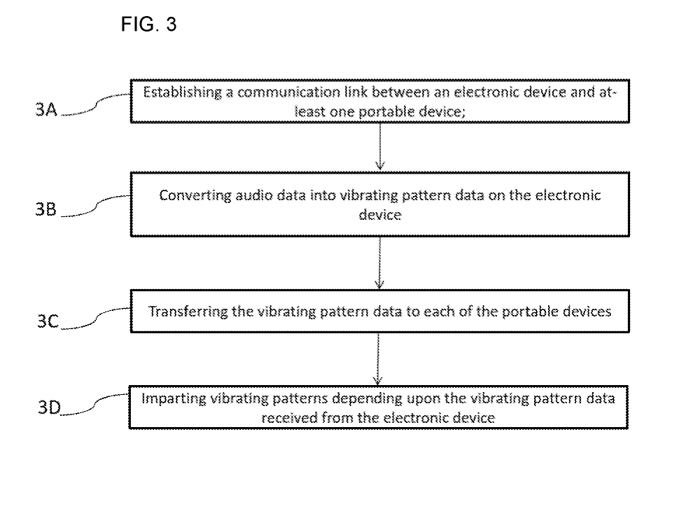

FIG. 3 shows a flow-chart of a method for transforming audio data into vibrating patterns. In order to perform such a method, a system such as the system shown in FIG. 1 may be used.

The method begins at step 3A, where a communication link is established between an electronic device and at-least one portable device. At step 3B, audio data is converted into vibrating pattern data on the electronic device. The electronic device includes an application embedded in the device for converting audio data into vibrating pattern data. For converting the audio data into vibrating pattern data, processor of the device analyses the audio data to detect speed as well as intensity of the audio data and depending upon the speed and intensity of the audio data corresponding vibrating pattern data having the same speed and intensity characteristics is produced. The audio data can be music which can be received or selected from an external source or is retrieved from the storage unit of the electronic device. Accordingly for music being converted speed and intensity of the music is converted into vibrating patterns having speed and intensity characteristics of the music. The audio data can also be speech of a user which can be received through a microphone of the electronic device. Accordingly for speech being converted, speed and intensity of each syllable of the speech is converted into vibrating patterns having speed and intensity characteristics of the syllables of the speech. Alternately for speech being converted, syllables in the audio data is identified, and co-related with pre-stored vibrating patterns, whereby the pre-stored vibrating pattern have speed and/or intensity corresponding to the syllables. In this regard, corresponding vibrating patters are assigned and stored for different syllables, and on receiving such syllables, the system retrieves the corresponding vibrating pattern. Further, the storage unit also has preset vibrating patterns which may not involve any conversion from audio data to vibrations. The vibrating pattern data at step 3C is transferred to at-least one portable device. At step 3D, the portable device converts the vibrating pattern data to impart vibrating patterns through at-least one vibrating mechanism depending upon the vibrating pattern data received from the electronic device.

In an embodiment of the invention, the electronic device can be connected to plurality of portable devices allowing users to participate in synchronous activities such as dancing or sporting activities. For example users participating in rowing need to have rowing strokes at the same instance. With the present invention, instead of person calling codes vocally, the portable device can vibrate to indicate or command to the users to perform the rowing stroke. Similarly, for other sports or even for performing mass synchronized activity like pushing or lifting heavy weights by a group of people the present invention can be implemented.

Advantageously, methods, systems and devices of the present invention provide a vibrating language that enables hearing impaired individuals to perceive/sense and understand audio data such as music, speech through sense of touch i.e. the vibrating patterns.

While the present invention has been described with respect to certain embodiments, it will be apparent to those skilled in the art that various changes and modification may be made without departing from the scope of the invention as defined in the following claims.

We claim:

1. A system for transforming audio data into vibrating patterns, the system comprising:
an electronic device configured for converting audio data into vibrating pattern data; and
a portable device in communication with the electronic device for receiving the vibrating pattern data, the portable device having at-least one vibrating mechanism for imparting vibrating patterns depending upon the vibrating pattern data.

2. The system as claimed in claim 1, wherein the electronic device is selected from the group consisting of smart-phones, laptops, and a tablet-pc.

3. The system as claimed in claim 1, wherein the electronic device includes an application embedded in the device for converting audio data into vibrating pattern data.

4. The system as claimed in claim 1, wherein for converting the audio data into vibrating pattern data, the device analyzes the audio data to detect speed or intensity or both of the audio data and depending upon the speed or intensity of the audio data corresponding vibrating pattern data is produced.

5. The system as claimed in claim 1, wherein for converting the audio data into vibrating pattern data, the device analyzes the audio data to identify syllables in the audio data, and correlates the syllables with pre-stored vibrating patterns, the pre-stored vibrating pattern having speed and/or intensity corresponding to the syllables.

6. The system as claimed in claim 1, wherein the portable device is a wearable device selected the group consisting of a ring, a bracelet, a band, a watch, a smart-watch, and a pendant.

7. The system as claimed in claim 1, wherein the portable device includes a communication module for receiving the vibrating pattern data, a processor configured to convert the vibrating pattern data to vibrating pattern, and the vibrating mechanism for imparting vibrations.

8. The system as claimed in claim 1, wherein the vibrating mechanism of the portable device is selected from the group consisting of a vibrating motor, a piezoelectric translator, and a voice coil.

9. The system as claimed in claim 1, wherein the electronic device and the portable device communicate over any of a radio frequency network, a GSM network, a CDMA network, a WI-FI or WI-MAX network, a Bluetooth network, an infrared network.

10. A method for transforming audio data into vibrating patterns, the method comprising the steps of
establishing a communication link between an electronic device and at-least one portable device;
converting audio data into vibrating pattern data on the electronic device; and
transferring the vibrating pattern data to each of the portable devices, the portable device imparting vibrating patterns depending upon the vibrating pattern data received from the electronic device.

11. The method as claimed in claim 10, wherein the step of converting the audio data into includes analyzing the audio data to detect speed or intensity or both of the audio data and producing vibrating pattern data depending upon the speed or intensity or both of the audio data.

12. The method as claimed in claim 10, wherein the step of converting the audio data includes analyzing the audio data to identify syllables in the audio data, and correlating the syllables with pre-stored vibrating patterns, the pre-stored vibrating pattern having speed or intensity or both corresponding to the syllables.
